(19) United States
(12) Patent Application Publication
(10) Pub. No.: US 2006/0017694 A1
(43) Pub. Date: Jan. 26, 2006

(54) Information processing device and information processing method

(75) Inventor: Daisuke Shikata, Saitama-ken (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/175,304

(22) Filed: Jul. 7, 2005

(30) Foreign Application Priority Data
Jul. 21, 2004 (JP) 2004-213149

(51) Int. Cl. G09G 5/08

(52) U.S. Cl. 345/158

(57) ABSTRACT

An information processing device and method which are capable, when an attitude of a device differs from an attitude thereof at times of usual use and a previously specified allocation of functions to a plurality of operation buttons is changed, of improving operability of the operation buttons. In a digital camera serving as the information processing device, an attitude of the digital camera is detected by a CPU and an attitude sensor. When the detected attitude differs from an attitude of the digital camera at times of ordinary use, an allocation of functions to a plurality of operation buttons, which are included at an operation section, is changed in accordance with the detected attitude. Notification of this change is given by display by an LCD and emission of a buzzer sound by a speaker, or the like.

### CROSS-REFERENCE TO RELATED APPLICATION

This application claims priority under 35 USC 119 from Japanese Patent Application No. 2004-213149, the disclosure of which is incorporated by reference herein.

### BACKGROUND OF THE INVENTION

1. Field of the Invention

The present invention relates to an information processing device and an information processing method, and particularly relates to an information processing device which features a plurality of operation buttons to which pre-specified functions are allocated, the functions being executed by operation of the respective buttons, and an information processing method of this device.

2. Description of the Related Art

With the technological revolution of recent years, there has been progress in the miniaturization of information processing devices such as workstations, personal computers and the like. More recently, a great number of PDAs (personal digital assistants, which are portable information terminals), which are smaller than notebook-type personal computers, have come onto the market.

Meanwhile, in accordance with increases in resolution of image capture elements such as CCD (charge coupled device) area sensors, CMOS (complementary metal oxide semiconductor) image sensors and the like, demand for digital cameras has grown rapidly in recent years.

A portable information processing device, such as one of the above-mentioned PDAs, digital cameras or the like, is provided with a plurality of operation buttons to which pre-specified functions are allocated, which functions are executed by operation of the respective buttons. However, there are many cases in which the information processing device, being portable, may be turned for use. For example, a PDA or digital camera is generally provided with a display device, such as a liquid crystal display or the like, which has a display area with an aspect ratio which is not 1:1. When a rectangular image is to be displayed by the display device, the overall image can be shown larger if the image is displayed such that a long direction of the image coincides with a long direction of the display area of the display device. Accordingly, the image display device may be used with a main body thereof in a state which is tipped sideways (a state of having been turned by 90°).

At such a time, an arrangement of the plurality of operation buttons provided at the information processing device is also turned about an axis of turning of the information processing device. Consequently, there is a problem in that operability of the operation buttons is adversely affected.

As a technology which can be applied for solving this problem, heretofore, a direction sensor has been provided inside a casing of a device. The direction sensor detects whether or not a length direction of a liquid crystal display (a vertical direction in an ordinary state of the device) has been oriented to a horizontal direction. When the direction sensor detects a horizontal direction orientation, an image displayed by the liquid crystal display is turned by 90°. There has also been technology for scrolling an image displayed at a liquid crystal display leftward/rightward and forward/backward in accordance with key operations of forward/backward-scrolling keys and leftward/rightward-scrolling keys (a “cross-cursor button”) provided at a front face of a casing; that is, a technology for changing scrolling directions of the scrolling keys (for example, Japanese Patent Application Laid-Open (JP-A) No. 8-129557).

However, with the above-described technology for changing scrolling directions of respective scroll keys, a user may not immediately understand that the functions that were previously allocated to the respective scroll keys have been changed. Consequently, functions that are executed in response to key operations may be different from the functions that the user was expecting. Thus, this technology cannot necessarily be considered to improve operability, and this is problematic.

### SUMMARY OF THE INVENTION

The present invention has been devised in order to solve the problem described above, and will provide an information processing device and an information processing method which are capable, when an attitude of a device differs from an attitude thereof at a time of ordinary use and a previously specified allocation of functions to a plurality of operation buttons is changed, of improving operability of the operation buttons.

A first aspect of the present invention provides an information processing device which includes: a plurality of operation buttons, to which pre-specified functions, to be executed by operation of the respective buttons, are allocated; an attitude detection section which detects an attitude of the information processing device; a function alteration section which, when the attitude detected by the attitude detection section differs from an attitude of times of ordinary use of the information processing device, changes an allocation of functions to the plurality of operation buttons in accordance with the detected attitude; and a notification section which, when the allocation of functions is changed by the function alteration section, gives notification of this change to a user of the device.

According to the information processing device of the first aspect, an orientation of the information processing device is detected by the attitude detection section. Herein, this attitude detection section can be one of various kinds of sensor that are capable of sensing attitudes of information processing devices, such as attitude sensors with gyros and the like, the mercury sensor described in JP-A No. 8-129557, and so forth.

With the present invention, if an attitude detected by the attitude detection section differs from the attitude of the information processing device for times of ordinary use, the allocation of functions to the plurality of operation buttons is changed in accordance with the attitude detected by the attitude detection section, and notification of this change is given by the notification section to a user of the device.

Thus, with the information processing device of the first aspect, the user can be immediately caused to understand that the functions previously assigned to the respective operation buttons have changed. As a result, operability of the plurality of operation buttons can be improved.

Herein, the information processing device may further include: a display section for displaying a pre-specified menu screen; and a rotated display section which, if the attitude detected by the attitude detection section differs from the attitude of times of ordinary use of the information processing device when the menu screen is being displayed by the display section, rotates the menu screen for display in accordance with the detected attitude, such that a vertical direction of the menu screen substantially coincides with a vertical direction of the information processing device at that point in time. As a result, it is possible to improve viewability of the menu display, and usability can be improved. Herein, the display section can be one of various kinds of display device, such as liquid crystal displays, plasma displays, organic EL displays, CRT displays, electronic papers (which are paper-like displays) and so forth.

Further, an imaging section which acquires image information representing a subject image by image capture may also be provided, with the display section displaying the subject image represented by the image information acquired by the imaging section, and the pre-specified functions including at least one of the following sets of functions: (1) when the subject image is being displayed by the display section, functions for implementing enlargement and reduction of the subject image; (2) when a plurality of the subject image are being displayed one image at a time by the display section, a function for implementing display substitution in order of capture by the imaging section and a function for implementing display substitution in reverse order of the order of capture; and (3) when a sound relating to the subject image is played, functions for implementing an increase and a reduction in sound volume. As a result, operability of the operation buttons to which the applied functions are allocated can be improved. Herein, the imaging section can be one of solid-state imaging elements, such as CCD area sensors, CMOS image sensors and so forth.

Further still, the notification by the notification section may include at least one of notification by sound and notification by display. Hence, when notification by sound is employed, a user can easily learn aurally that the functions previously allocated to the respective operation buttons have been changed. Further, when notification by display is employed, a user can easily learn visually that the functions previously allocated to the respective operation buttons have been changed. Herein, the notification by sound can be notification by sounding of a speaker, a buzzer or the like, notification by playback of a predetermined voice message, or the like. Further, the notification by display can be one of notification by display of a predetermined message, a predetermined symbol or the like at the display section, and/or notification by illumination or flashing of a light-emission portion such as a light-emitting diode or the like.

A second aspect of the present invention provides an information processing method for an information processing device which includes a plurality of operation buttons, to which pre-specified functions, to be executed by operation of the respective buttons, are allocated, which information processing method includes: detecting an attitude of the information processing device; when the detected attitude differs from an attitude of times of ordinary use of the information processing device, changing an allocation of functions to the plurality of operation buttons in accordance with the detected attitude; and giving notification of this change to a user of the device.

The method of the second aspect acts similarly to the information processing device according to the first aspect. Therefore, similarly, a user can immediately understand that functions previously assigned to the respective operation buttons have been changed and, as a result, operability of the plurality of operation buttons can be improved.

Thus, according to the information processing device and information processing method relating to the present invention, the attitude of an information processing device is detected and, if the detected attitude differs from an attitude of times of ordinary use, functions allocated to a plurality of operation buttons are changed in accordance with the detected attitude. Moreover, when notification is given of this change, a user can be promptly caused to understand that the functions previously allocated to the respective operation buttons have been changed. As a result, a benefit is provided in that operability in relation to the plurality of operation buttons can be improved.

### BRIEF DESCRIPTION OF THE DRAWINGS

FIG. 1 is external views showing the external appearance of a digital camera 10 relating to an embodiment of the present invention.

FIG. 2 is a block diagram showing general structure of an electronic system of the digital camera 10 relating to the present embodiment.

FIG. 3 is a flowchart showing the flow of processing of an allocation change notification processing program relating to the present embodiment.

FIGS. 4A and 4B are schematic views showing examples of display conditions of a function indication image, which is displayed by execution of the allocation change notification processing program relating to the present embodiment.

FIGS. 5A to 5D are schematic views showing examples of display conditions of a menu screen, which are implemented by execution of the allocation change notification processing program relating to the present embodiment.

### DETAILED DESCRIPTION OF THE INVENTION

Hereinafter, an embodiment of the present invention will be described in detail with reference to the drawings. Herein, the information processing device and information processing method relating to the present invention will be described for a case of application to a digital camera which features functions for performing image capture of both still images and moving images.

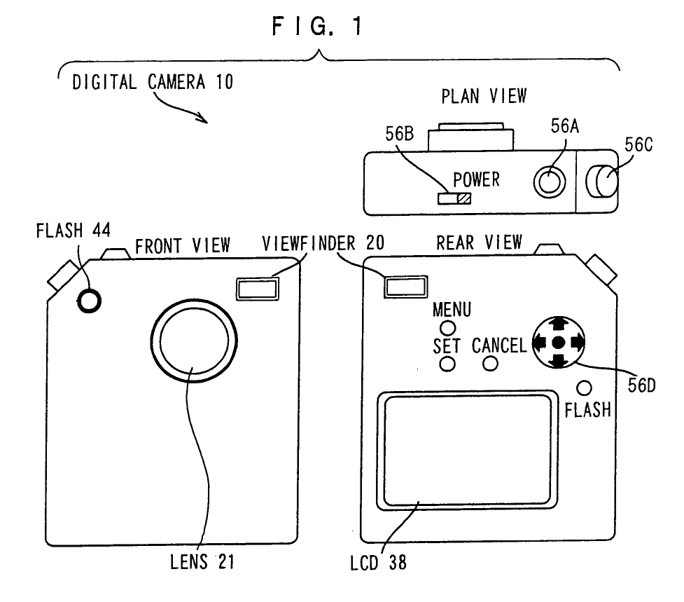

First, referring to FIG. 1, structures on the exterior of a digital camera 10 relating to the present embodiment will be described.

A lens 21, a flash 44 and a viewfinder 20 are provided at a front face of the digital camera 10. The lens 21 is for focusing an image of a subject. The flash 44 emits light which illuminates the subject at a time of image capture, in accordance with requirements. The viewfinder 20 is used for determining the composition of the subject to be captured. A release button (the “shutter”) 56A, a power switch 56B and a mode-changing switch 56C are provided at an upper face of the digital camera 10. The release button 56A is pressed for operation when image capture is to be executed.

The release button 56A of the digital camera 10 relating to the present embodiment is structured to be capable of sensing a two-stage pressing operation: a state which is pressed down to an intermediate position (hereinafter referred to as a half-pressed state) and a state which is pressed beyond the intermediate position to a lowermost position (hereinafter referred to as a full-pressed state).

In the digital camera 10, an AE (automatic exposure) function operates and exposure conditions (shutter speed and aperture) are specified when the release button 56A is half-pressed. Thereafter, an AF (auto focus) function operates to regulate focusing, and exposure (image capture) is performed when the release button 56A is further pressed to the full-pressed state.

The mode-changing switch 56C is turned for operation when one of a still image capture mode, a moving image capture mode and a playback mode is to be selected. The still image capture mode is a mode for performing photography of still images. The moving image capture mode is a mode for performing filming of moving images. The playback mode is a mode for replaying images of subjects at a liquid crystal display 38, which will be described later.

At a rear face of the digital camera 10, an eyepiece portion of the aforementioned viewfinder 20, the liquid crystal display (hereinafter referred to as “LCD”) 38 and a cross-cursor button 56D are provided. The LCD 38 is for displaying captured subject images, menu screens and the like. The cross-cursor button 56D is a structure which includes four arrow buttons representing four directions of movement—up, down, left and right—of a display region of the LCD 38 (hereinafter referred to as an up arrow button, a down arrow button, a left arrow button and a right arrow button, respectively).

A menu button, a set button, a cancel button, and a flash button are also provided at the rear face of the digital camera 10. The menu button is pressed for operation when a menu screen is to be displayed on the LCD 38. The set button is pressed for operation when details of operations up to that point in time are to be confirmed. The cancel button is pressed for operation when the details of a most recent operation are to be cancelled. The flash button is pressed for operation when a light emission condition of the flash 44 is to be set.

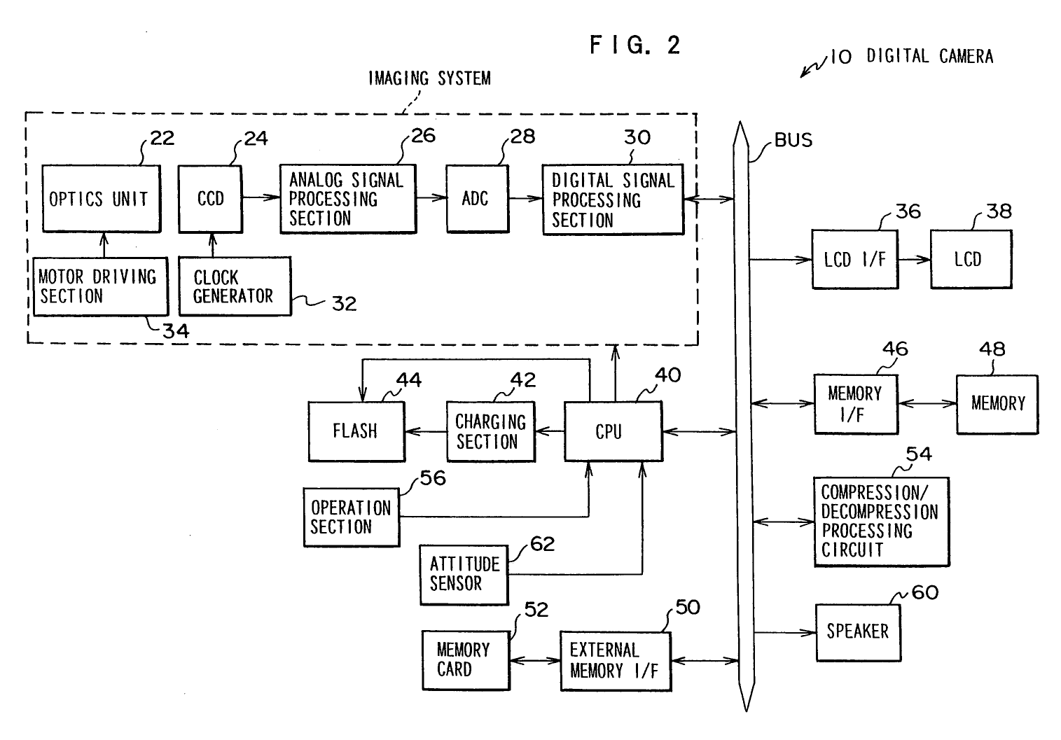

Next, referring to FIG. 2, general structure of an electronic system of the digital camera 10 relating to the present embodiment will be described.

The digital camera 10 is structured to include an optics unit 22, a charge coupled device (hereinafter referred to as “CCD”) 24 and an analog signal processing section 26. The optics unit 22 is structured to include the aforementioned lens 21. The CCD 24 is disposed on an optical axis of the lens 21 at a rear side thereof. The analog signal processing section 26 performs various kinds of analog signal-processing on analog signals inputted thereto.

The digital camera 10 is further structured to include an analog/digital converter (hereinafter referred to as “ADC”) 28 and a digital signal processing section 30. The ADC 28 converts analog signals inputted thereto to digital data. The digital signal processing section 30 performs various kinds of digital signal-processing on digital data inputted thereto.

The digital signal processing section 30 incorporates a line buffer with a predetermined capacity, and performs control so as to directly store the inputted digital data at a predetermined region of a memory 48, which will be discussed later.

An output terminal of the CCD 24 is connected to an input terminal of the analog signal processing section 26, an output terminal of the analog signal processing section 26 is connected to an input terminal of the ADC 28, and an output terminal of the ADC 28 is connected to an input terminal of the digital signal processing section 30. Accordingly, an analog signal representing a subject image, which is outputted from the CCD 24, is subjected to predetermined analog signal-processing by the analog signal processing section 26, is converted to digital image data by the ADC 28, and is then inputted to the digital signal processing section 30.

The digital camera 10 is further structured to include an LCD interface 36, a CPU (central processing unit) 40, the memory 48 (a memory device) and a memory interface 46. The LCD interface 36 generates signals for display of subject images, menu screens and the like at the LCD 38, and supplies the signals to the LCD 38. The CPU 40 administers overall operations of the digital camera 10. The memory 48 stores digital image date obtained by image captures, and the like. The memory interface 46 implements control of access to the memory 48.

The digital camera 10 is further structured to include an external memory interface 50, a compression/decompression processing circuit 54 and a speaker 60. The external memory interface 50 is for enabling access by the digital camera 10 to a portable memory card 52. The compression/decompression processing circuit 54 performs compression processing and decompression processing on the digital image data. The speaker 60 plays sounds such as voices, buzzers and the like.

In the digital camera 10 of the present embodiment, a flash memory is employed as the memory 48 and a SMART MEDIA® is employed as the memory card 52.

The digital signal processing section 30, the LCD interface 36, the CPU 40, the memory interface 46, the external memory interface 50, the compression/decompression processing circuit 54 and the speaker 60 are connected to one another via a system bus BUS. Thus, the CPU 40 can perform control of operations of the digital signal processing section 30 and the compression/decompression processing circuit 54, display various kinds of information on the LCD 38 via the LCD interface 36, implement access to the memory 48 and the memory card 52 via the memory interface 46 and the external memory interface 50, and play various sounds with the speaker 60.

The digital camera 10 is further provided with a clock generator 32 which generates timing signals, principally for driving the CCD 24, and supplies the timing signals to the CCD 24. Driving of the CCD 24 is controlled by the CPU 40 via the clock generator 32.

Further still, a motor driving section 34 is provided in the digital camera 10. Driving of an unillustrated focal point adjustment motor, zoom motor and aperture-driving motor, which are provided at the optics unit 22, is controlled by the CPU 40 via the motor driving section 34.

The lens 21 relating to the present embodiment includes a number of lenses, and is structured as a zoom lens which is capable of altering a focusing distance (magnification). The lens 21 is equipped with an unillustrated lens-driving mechanism. This lens-driving mechanism includes the above-mentioned focal point adjustment motor, zoom motor and aperture-driving motor. These motors are respectively driven by driving signals supplied from the motor driving section 34 in accordance with control by the CPU 40.

Various buttons and switches (which are shown all together as an operation section 56 in FIG. 2), such as the aforementioned release button 56A, power switch 56B, mode-changing switch 56C, cross-cursor button 56D, menu button and so forth, are connected to the CPU 40. The CPU 40 can constantly acquire operation states of the operation section 56.

The digital camera 10 is further equipped with a charging section 42. The charging section 42 is interposed between the flash 44 and the CPU 40, and supplies electrical power for emitting light from the flash 44, in accordance with control by the CPU 40. The flash 44 is also connected to the CPU 40, and light emission from the flash 44 is controlled by the CPU 40.

In the digital camera 10 relating to the present embodiment, an attitude sensor 62 is provided for detecting attitudes of the digital camera 10. An output terminal of the attitude sensor 62, which outputs information representing results of sensing by the attitude sensor 62, is connected to the CPU 40. Thus, the CPU 40 can ascertain the attitude of the digital camera 10. Here, a gyro is employed as the attitude sensor 62 in the digital camera 10 relating to the present embodiment, but this is not a limitation. Any sensor that is capable of detecting attitude, such as the mercury sensor described in JP-A No. 8-129557 or the like, can be employed.

Next, overall operations of the digital camera 10 relating to the present embodiment at a time of image capture will be briefly described.

First, the CCD 24 performs imaging through the optics unit 22, and sequentially outputs analog signals representing the subject image, of each of R (red), G (green), and B (blue), to the analog signal processing section 26. The analog signal processing section 26 performs analog signal-processing, such as correlated double sampling processing and the like, on the analog signals inputted from the CCD 24, and then sequentially outputs analog signals to the ADC 28.

The ADC 28 converts the respective R, G and B analog signals inputted from the analog signal processing section 26 to respective 12 bit R, G and B signals (i.e., digital image data), and sequentially outputs these signals to the digital signal processing section 30. The digital signal processing section 30 accumulates the digital image data that is sequentially inputted from the ADC 28 at the incorporated line buffer, and temporarily stores the digital image data directly to a predetermined region of the memory 48.

The digital image data that has been stored at the predetermined region of the memory 48 is read out by the digital signal processing section 30 in response to control by the CPU 40. The digital signal processing section 30 implements white balance control by the application of digital gain in accordance with predetermined physical quantities, performs gamma processing and sharpness processing, and generates 8-bit digital image data. Then, the digital signal processing section 30 performs YC signal processing on the thus-generated 8-bit digital image data, to generate brightness signals Y and chroma signals Cr and Cb (hereinafter referred to as “YC signals”), and stores the YC signals at a region of the memory 48 other than the above-mentioned predetermined region.

Herein, the LCD 38 is structured as a display which displays a moving image (a through-image) obtained by continuous imaging by the CCD 24, and can be used as a viewfinder. When the LCD 38 is used as a viewfinder, the generated YC signals are sequentially outputted via the LCD interface 36 to the LCD 38. Thus, the LCD 38 displays the through-image.

Now, if the still image capture mode is selected, at a time at which the release button 56A is half-pressed by a user, the AE function operates to set exposure conditions as mentioned earlier. Then, the AF function operates to control focusing. Thereafter, at a time at which the release button 56A continues to the full-pressed state, the YC signals that are stored in the memory 48 at that point in time are compressed in a predetermined compression format (in the present embodiment, JPEG) by the compression/decompression processing circuit 54 and are stored, via the external memory interface 50, as an electronic file at the memory card 52.

Alternatively, if the moving image capture mode is selected, from a time at which the release button 56A is full-pressed, YC signals that are stored in the memory 48 from that point in time are compressed in a predetermined compression format (in the present embodiment, Motion JPEG) by the compression/decompression processing circuit 54 at predetermined intervals in a time series, and proceed to be sequentially recorded to the memory card 52, via the external memory interface 50. At a time at which the release button 56A is full-pressed again, this recording operation finishes. By such operations, moving image data representing moving images is recorded at the memory card 52 as an electronic file.

An allocation change notification function is incorporated in the digital camera 10 relating to the present embodiment. The allocation change notification function detects an attitude of the digital camera 10 with the attitude sensor 62 and, when the detected attitude is different from an attitude of times of ordinary use of the digital camera 10, changes an allocation of functions to predetermined operation buttons (the cross-cursor button 56D in the present embodiment) in accordance with the detected attitude, gives notification of this change, and executes processing for rotating a menu screen for display such that, when the menu screen is being displayed at the LCD 38, a vertical direction of the menu screen substantially coincides with a vertical direction of the digital camera 10 at that point in time. The attitude at times of ordinary use of this digital camera 10 herein is an attitude in which the release button 56A is disposed at an upper face, i.e., the attitude shown in FIG. 1.

In the digital camera 10 relating to the present embodiment, when an imaging mode—either of the still image capture mode and the moving image capture mode—is selected, the functions to be allocated to the respective arrow buttons of the cross-cursor button 56D are specified in advance for each attitude of the digital camera 10 in a number of stages, as shown in table 1 (herein, four stages: the attitude at times of ordinary use, an attitude when turned by 90°, an attitude when turned by 180°, and an attitude when turned by 270°). For the digital camera 10 relating to the present embodiment, each of the angles of turning is an angle representing an angle of rotation anticlockwise, in the rear face view of FIG. 1, about an imaginary central line extending in a front-rear direction of the digital camera 10.

TABLE 1

| | During | When turned | When turned | When turned |
|---|---|---|---|---|
| | ordinary use | by 90° | by 180° | by 270° |
| Up arrow | Enlarge | — | Reduce | — |
| button | captured | | captured | |
| | image | | image | |
| Down arrow | Reduce | — | Enlarge | — |
| button | captured | | captured | |
| | image | | image | |
| Left arrow | — | Reduce | — | Enlarge |
| button | | captured | | captured |
| | | image | | image |
| Right arrow | — | Enlarge | — | Reduce |
| button | | captured | | captured |
| | | image | | image |

As is shown in table 1, for example, while the digital camera 10 is in the attitude of times of ordinary use, a captured image is enlarged when the up arrow button is pressed for operation, and the captured image is reduced when the down arrow button is pressed for operation. Further, for example, while the digital camera 10 is in the attitude which is turned by 90°, the captured image is reduced when the left arrow button is pressed for operation and the captured image is enlarged when the right arrow button is pressed for operation. That is, with the functions of the respective buttons as shown in table 1, whichever of the attitudes of the above-described plurality of stages the digital camera 10 is put into, an arrow button that is disposed at an upper side in that attitude is assigned the function of instructing enlargement of the captured image and an arrow button that is disposed at a lower side is assigned the function of instructing reduction of the captured image. Therefore, whatever attitude the digital camera 10 is put into, operations for enlargement and reduction of captured images can be performed by operations with a similar feel to operations at times of ordinary use.

Here, in the digital camera 10 relating to the present embodiment, the information shown in table 1 (information representing functions allocated to the respective arrow buttons in each attitude) is stored beforehand at a predetermined region of the memory 48, in the form of a table or the like.

On the other hand, when the playback mode is selected at the digital camera 10 relating to the present embodiment, the functions to be allocated to the respective arrow buttons of the cross-cursor button 56D are set in advance for each attitude of the digital camera 10 in a number of stages (herein, the four stages: the attitude at times of ordinary use, the attitude when turned by 90°, the attitude when turned by 180°, and the attitude when turned by 270°), as shown in table 2.

TABLE 2

| | During | When | When | When |
|---|---|---|---|---|
| | ordinary | turned | turned | turned |
| | use | by 90° | by 180° | by 270° |
| Up arrow | Volume | Frame | Volume | Frame |
| button | up | rewind | down | advance |
| Down arrow | Volume | Frame | Volume | Frame |
| button | down | advance | up | rewind |
| Left arrow | Frame | Volume | Frame | Volume |
| button | rewind | down | advance | up |
| Right arrow | Frame | Volume | Frame | Volume |
| button | advance | up | rewind | down |

As is shown in table 2, for example, while the digital camera 10 is in the attitude of times of ordinary use, the volume of playback sound is turned up (increased) when the up arrow button is pressed for operation, and the volume of playback sound is turned down (reduced) when the down arrow button is pressed for operation. When a plurality of captured images are being displayed one at a time by the LCD 38, a display image is returned to an image one frame previous in reverse order of a sequence of capture when the left arrow button is pressed for operation, and the display image is advanced to an image one frame later in the sequence of capture when the right arrow button is pressed for operation. Further, for example, while the digital camera 10 is in the attitude which is turned by 90°, when a plurality of captured images are being displayed one at a time by the LCD 38, the display image is returned to the image one frame previous in reverse order of the sequence of capture when the up arrow button is pressed for operation, and the display image is advanced to the image one frame later in the sequence of capture when the down arrow button is pressed for operation. The volume of playback sound is turned down (reduced) when the left arrow button is pressed for operation, and the volume of playback sound is turned up (increased) when the right arrow button is pressed for operation.

That is, with the functions of the respective buttons as shown in table 2, whichever of the attitudes of the above-described plurality of stages the digital camera 10 is put into, an arrow button that is disposed at the upper side in that attitude is assigned the function of turning up the volume of playback sound, an arrow button that is disposed at the lower side is allocated the function of turning down the volume of playback sound, and, when a plurality of captured images are being displayed one at a time by the LCD 38, an arrow button that is disposed at the left side is assigned the function of rewinding to an image one frame previous in reverse order of the order of capture and an arrow button that is disposed at the right side is allocated the function of advancing to an image one frame later in the order of capture. Thus, whatever attitude the digital camera 10 is put into, operations for turning the volume up and down and for frame-feeding display images can be performed by operations with a similar feel to operations at times of ordinary use.

Here, in the digital camera 10 relating to the present embodiment, the information shown in table 2 (information representing functions allocated to the respective arrow buttons in each attitude) is also stored beforehand at a predetermined region of the memory 48, in the form of a table or the like.

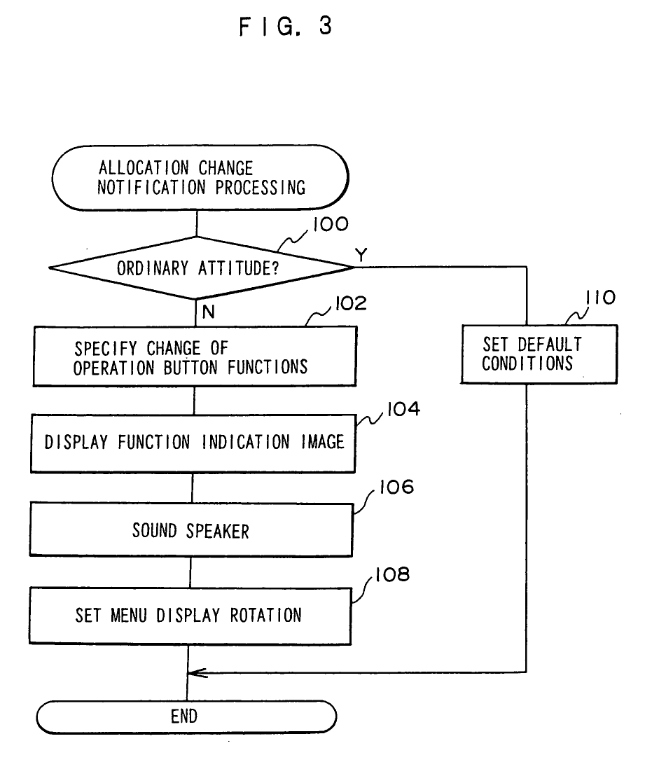

Next, with reference to FIG. 3, operations of the digital camera 10 at a time of execution of the allocation change notification function will be described. FIG. 3 is a flow chart which shows the flow of processing of an allocation change notification processing program which is executed by the CPU 40 of the digital camera 10 at predetermined time intervals (once per second in the present embodiment) in order to implement the allocation change notification function. This program is stored beforehand at a predetermined region of the memory 48.

In step 100 of FIG. 3, it is judged whether or not an attitude of the digital camera 10, which is represented by information inputted from the attitude sensor 62, is the attitude for times of ordinary use. If this judgment is negative, the program advances to step 102.

In step 102, functions which are to be allocated to the respective arrow buttons, in accordance with the operation mode that is selected at this point in time (one of the still image capture mode, the moving image capture mode and the playback mode) and the attitude of the digital camera 10 at this point in time as represented by the information inputted from the attitude sensor 62, are read from the information recorded beforehand at the memory 48 (see tables 1 and 2), and are set to be assigned to the arrow buttons that are to correspond to the functions that have been read out. Thus, for example, if the operation mode selected at this time is the playback mode and the attitude of the digital camera 10 is the attitude which is turned by 90°, the function for frame-rewinding the displayed image is allocated to the up arrow button, the function for frame-advancing the display image is allocated to the down arrow button, the function for turning down the volume of playback sound is allocated to the left arrow button and the function for turning up the volume of playback sound is allocated to the right arrow button.

Then, in step 104, in order to give notification that the functions allocated to the respective arrow buttons of the cross-cursor button 56D have been changed, an image which shows the functions that have been newly assigned to the respective arrow buttons of the cross-cursor button 56D (hereinafter referred to as a function indication image) is displayed at the LCD 38. In a subsequent step 106, the speaker 60 is caused to emit a predetermined buzzer sound.

Then, in a subsequent step 108, the menu screen is set to be turned for display such that a vertical direction of the menu screen, when the menu screen is being displayed by the LCD 38, coincides with a vertical direction of the attitude of the digital camera 10 that has been sensed by the attitude sensor 62 at this point in time. Thereafter, this allocation change notification processing program finishes.

On the other hand, if the judgment in step 100 is positive, the program advances to step 110. In step 110, functions which are to be allocated to the respective arrow buttons, in accordance with the operation mode that is selected at this point in time (one of the still image capture mode, the moving image capture mode and the playback mode) and the attitude of times of ordinary use, are read from the information recorded beforehand at the memory 48 (see tables 1 and 2), and are specified to be assigned to the arrow buttons that are to correspond to the functions that have been read out. Further, if the menu screen has been set to be turned for display when the menu screen is being displayed by the LCD 38, this setting is cancelled. Thus, the function settings for the arrow buttons of the cross-cursor button 56D and the display state of the menu screen are set to a default state. Thereafter, this allocation change notification processing program finishes.

Thus, with this allocation change notification processing program, the functions that are allocated to the respective arrow buttons of the cross-cursor button 56D can be set to functions corresponding to the attitude of the digital camera 10.

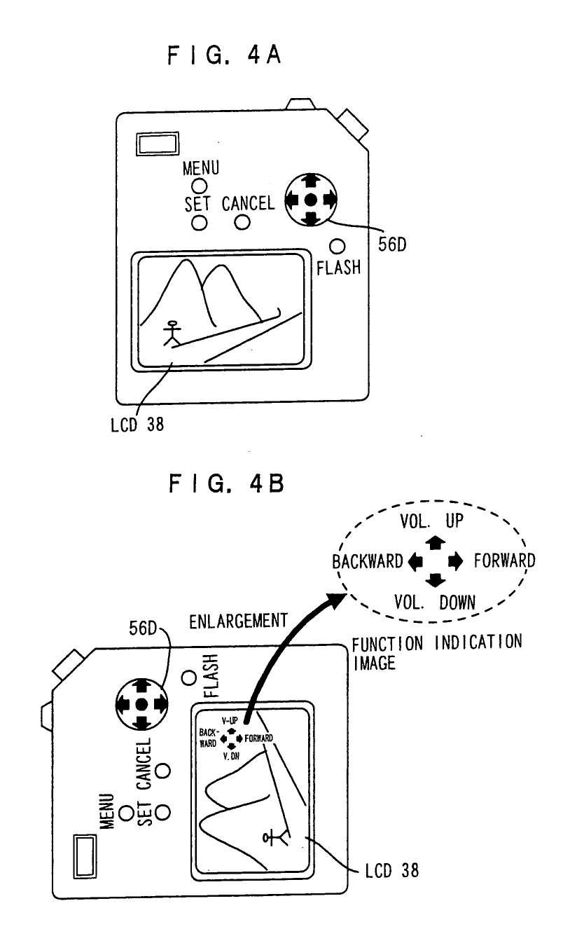

Moreover, with this allocation change notification processing program, if a display condition of the LCD 38 at a time of ordinary use is the condition shown in FIG. 4A, when the digital camera 10 is turned by 90°, a function indication image is displayed as shown by the example in FIG. 4B and a buzzer sound is emitted. Thus, notification can be given to a user that the allocation of functions to the respective arrow buttons has changed.

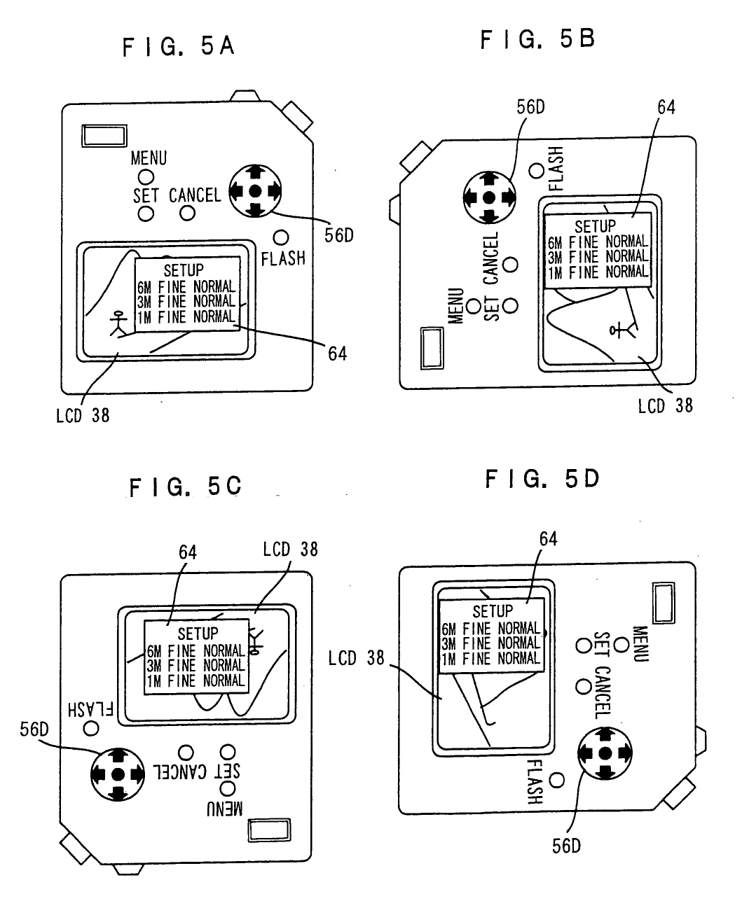

Furthermore, with this allocation change notification processing program, whichever state the attitude of the digital camera 10 is in, a menu screen 64 can be displayed in the same state, as is shown by the examples in FIGS. 5A to 5D, with a vertical direction of the menu screen 64 coinciding with vertical directions of the digital camera 10.

The processing of step 102 of this allocation change notification processing program corresponds to a function alteration section of the present invention, the processing of steps 104 and 106 corresponds to a notification section of the present invention, and the processing of step 108 correspond to a rotated display section of the present invention.

As has been described in detail hereabove, with the present embodiment, an attitude of the digital camera 10 is detected and, if the detected attitude differs from the attitude at times of ordinary use of the digital camera 10, the allocation of functions to the plurality of operation buttons (the arrow buttons) is changed in accordance with the detected attitude and notification is given of this change. Consequently, a user can immediately understand that the functions previously allocated to the respective operation buttons have been changed and, as a result, operability with respect to the plurality of operation buttons can be improved.

Further, in the present embodiment, when a menu screen is to be displayed by a display section (the LCD 38), if the attitude differs from the attitude at times of ordinary use of the digital camera 10, the menu screen is turned for display in accordance with the detected attitude, such that a vertical direction of the menu screen coincides with a vertical direction of the digital camera 10 at that point in time. Consequently, viewability of the menu screen can be improved, and usability can be improved.

Further yet, in the present embodiment, the functions allocated to the plurality of operation buttons are set as three sets of functions: when a subject image is being displayed by the display section, a function for implementing enlargement of the subject image and a function for implementing a reduction of the subject image; when a plurality of subject images are being displayed one image at a time by the display section, a function for implementing display substitution in order of capture and a function for implementing display substitution in reverse order of the order of capture; and, when a sound relating to a subject image is to be played, a function for implementing an increase in volume and a function for implementing a reduction in the volume. Thus, operability with respect to the operation buttons to which these functions are allocated can be improved.

Further again, in the present embodiment, the notification that the allocation of functions to the plurality of operation buttons has changed is implemented by both notification by sound and notification by display. As a result, a user can easily be caused to understand, aurally and visually, that the functions previously allocated to the respective operation buttons have been changed.

Herein, a case in which a change in the allocation of functions to the respective operation buttons is realized by software has been described for the present embodiment. However, the present invention is not limited thus. For example, modes in which this change is implemented by hardware are also possible. As an example of such a case, it is possible to provide a switch along connection wiring which is for electrically connecting the arrow buttons of the cross-cursor button 56D with the CPU 40, with this switch being capable of switching connection paths from the respective operation buttons to the CPU 40 between the operation buttons. A mode can be exemplified in which this switch switches the functions of the arrow buttons such that the functions of the respective arrow buttons change as shown by the examples in tables 1 and 2, or the like, in response to attitudes of the digital camera 10. In such a case, the same effects can be realized as with the present embodiment.

Furthermore, for the present embodiment, a case in which the notification that the allocation of functions to the operation buttons has been changed and the specification of rotated display of the menu screen are always implemented when the attitude of the digital camera 10 differs from the attitude of times of ordinary use has been described. However, the present invention is not limited thus. For example, a mode is possible in which input of instructions as to whether or not this notification and specification are to be implemented is performed by a user, and implementation or non-implementation of this notification and specification are switched in response to this input of instructions. Such a case enables the setting of operations in accordance with contexts of use of the digital camera 10 and the like. Thus, usability can be improved.

Further still, for the present embodiment, a case in which the information shown in table 1 and table 2 is stored in the memory 48 has been described. However, the present invention is not limited thus. For example, a mode is possible in which such information is stored at an external memory device such as the memory card 52 or the like. In such a case, the same effects can be realized as with the present embodiment.

Moreover, structure of the digital camera 10 relating to the present embodiment (see FIGS. 1 and 2) is an example. Appropriate modifications can be applied within a scope that does not depart from the spirit and the scope of the present invention.

Furthermore, the flow of processing of the allocation change notification processing program that has been described for the present embodiment (see FIG. 3) is also an example. Appropriate modifications can be applied within a scope that does not depart from the spirit of the present invention.

For example the processing of both step 104 and step 106 is not necessarily required; modes are possible in which one of these steps is eliminated and the other step is retained.

Further yet, for the present embodiment, a case of application of the present invention to a digital camera has been described. However, the present invention can be applied to any information processing device which features a plurality of operation buttons to which a plurality of pre-specified functions to be executed by operation of the respective buttons are allocated, such as PDAs, portable telephones, personal computers and so forth.

What is claimed is:

1. An information processing device comprising:
a plurality of operation buttons, to which pre-specified functions, to be executed by operation of the respective buttons, are allocated;
an attitude detection section which detects an attitude of the information processing device;
a function alteration section which, when the attitude detected by the attitude detection section differs from an attitude of times of ordinary use of the information processing device, changes an allocation of functions to the plurality of operation buttons in accordance with the detected attitude; and
a notification section which, when the allocation of functions is changed by the function alteration section, gives notification of this change to a user of the device.

2. The information processing device of claim 1, further comprising:
a display section for displaying a pre-specified menu screen; and
a rotated display section which, if the attitude detected by the attitude detection section differs from the attitude of times of ordinary use of the information processing device when the menu screen is being displayed by the display section, rotates the menu screen for display in accordance with the detected attitude, such that a vertical direction of the menu screen substantially coincides with a vertical direction of the information processing device at that point in time.

3. The information processing device of claim 2, further comprising an imaging section which acquires image information representing a subject image by image capture,
wherein the display section displays the subject image represented by the image information acquired by the imaging section, and
the pre-specified functions include at least one of the following sets of functions:
(1) when the subject image is being displayed by the display section, functions for implementing enlargement and reduction of the subject image;
(2) when a plurality of the subject image are being displayed one image at a time by the display section, a function for implementing display substitution in order of capture by the imaging section and a function for implementing display substitution in reverse order of the order of capture; and
(3) when a sound relating to the subject image is played, functions for implementing an increase and a reduction in sound volume.

4. The information processing device of claim 1, wherein the notification by the notification section comprises at least one of notification by sound and notification by display.

5. The information processing device of claim 2, wherein the display section comprises a display selected from liquid crystal displays, plasma displays, organic EL displays CRT displays, and electronic papers.

6. The information processing device of claim 3, wherein the imaging section comprises a sensor selected from CCD area sensors and CMOS image sensors.

7. The information processing device of claim 1, further comprising a memory device,
wherein the memory device stores information representing the allocation of functions to the plurality of operation buttons to correspond with at least one attitude of the information processing device.

8. The information processing device of claim 7, wherein the function alteration section changes the allocation of functions to the plurality of operation buttons by, in accordance with the attitude detected by the attitude detection section, reading allocation information of functions that are to correspond with the plurality of operation buttons from the memory device.

9. The information processing device of claim 7, wherein the memory device comprises an external memory device.

10. The information processing device of claim 1, wherein the function alteration section implements the change in allocation of functions to the plurality of operation buttons in accordance with an instruction from a user of the device.

11. The information processing device of claim 1, wherein the information processing device comprises a device selected from digital cameras, personal digital assistants, portable telephones and personal computers.

12. An information processing method for an information processing device which includes a plurality of operation buttons, to which pre-specified functions, to be executed by operation of the respective buttons, are allocated, the information processing method comprising:
detecting an attitude of the information processing device;
when the detected attitude differs from an attitude of times of ordinary use of the information processing device, changing an allocation of functions to the plurality of operation buttons in accordance with the detected attitude; and
giving notification of this change to a user of the device.

13. The information processing method of claim 12, further comprising:
displaying a pre-specified menu screen,
wherein, if the detected attitude differs from the attitude of times of ordinary use of the information processing device when the menu screen is being displayed, the menu screen is rotated for display in accordance with the detected attitude, such that a vertical direction of the menu screen substantially coincides with a vertical direction of the information processing device at that point in time.

14. The information processing method of claim 13, further comprising:
acquiring image information representing a subject image by image capture; and
displaying the subject image represented by the acquired image information,
wherein the pre-specified functions include at least one of the following sets of functions:
(1) when the subject image is being displayed, functions for implementing enlargement and reduction of the subject image;
(2) when a plurality of the subject image are being displayed one image at a time, a function for implementing display substitution in order of image capture and a function for implementing display substitution in reverse order of the order of image capture; and
(3) when a sound relating to the subject image is played, functions for implementing an increase and a reduction in sound volume.

15. The information processing method of claim 12, wherein the notification comprises at least one of notification by sound and notification by display.

16. The information processing method of claim 12, further comprising:
storing information representing the allocation of functions to the plurality of operation buttons to correspond with at least one attitude of the information processing device.

17. The information processing method of claim 16, wherein changing the allocation of functions to the plurality of operation buttons comprises:
reading the stored allocation information of functions that are to correspond with the plurality of operation buttons in accordance with the detected attitude; and
changing the allocation of functions to the plurality of operation buttons on the basis of the information that has been read.

18. The information processing method of claim 12, wherein changing the allocation of functions to the plurality of operation buttons comprises implementing the change in the allocation of functions to the plurality of operation buttons in accordance with an instruction from a user of the device.
